(19) United States
(12) Patent Application Publication
(10) Pub. No.: US 2008/0258922 A1
(43) Pub. Date: Oct. 23, 2008

(54) Electronic patient treatment query

(75) Inventors: Timo Kaukonen, Oulu (FI); Matti Koivu, Oulu (FI)

Correspondence Address: YOUNG & THOMPSON, 209 Madison Street, Suite 500, ALEXANDRIA, VA, 22314, US

(73) Assignee: CORONARIA IMPACT OY, OULU (FI)

(21) Appl. No.: 11/785,296

(22) Filed: Apr. 17, 2007

(51) Int. Cl. G08B 23/00

(52) U.S. Cl. 340/573.1

(57) ABSTRACT

Processing of an electronic patient treatment query is disclosed. An apparatus includes: an input interface module configured to input patient data maintained in an electronic data system of a health care provider; a processing module configured to create a patient treatment query comprising a plurality of sections queried at predetermined times, to determine for each section a section result based on a patient response to the section, and to determine a total result based on the section results; and an output interface module configured to output the section results and the total result to the patient and the health care provider.

### FIELD

The invention relates to processing of an electronic patient treatment query.

### BACKGROUND

Traditionally, patient treatment queries have been performed as paper-based queries. Such manual work is very labor-intensive and slow; it is done in a sampling fashion to arrive at a cross-section type of query.

### BRIEF DESCRIPTION

The present invention seeks to provide an improved apparatus, computer program, method and another apparatus.

According to an aspect of the present invention, there is provided an apparatus as specified in claim 1.

According to another aspect of the present invention, there is provided a computer program as specified in claim 17.

According to another aspect of the present invention, there is provided a method as specified in claim 18.

According to another aspect of the present invention, there is provided an apparatus as specified in claim 34.

### LIST OF DRAWINGS

Embodiments of the present invention are described below, by way of example only, with reference to the accompanying drawings, in which

FIG. 1 illustrates embodiments of an apparatus;

FIGS. 2, 3 and 4 illustrate various dates relating to an electronic patient treatment query; and

FIG. 5 illustrates embodiments of a method.

### DESCRIPTION OF EMBODIMENTS

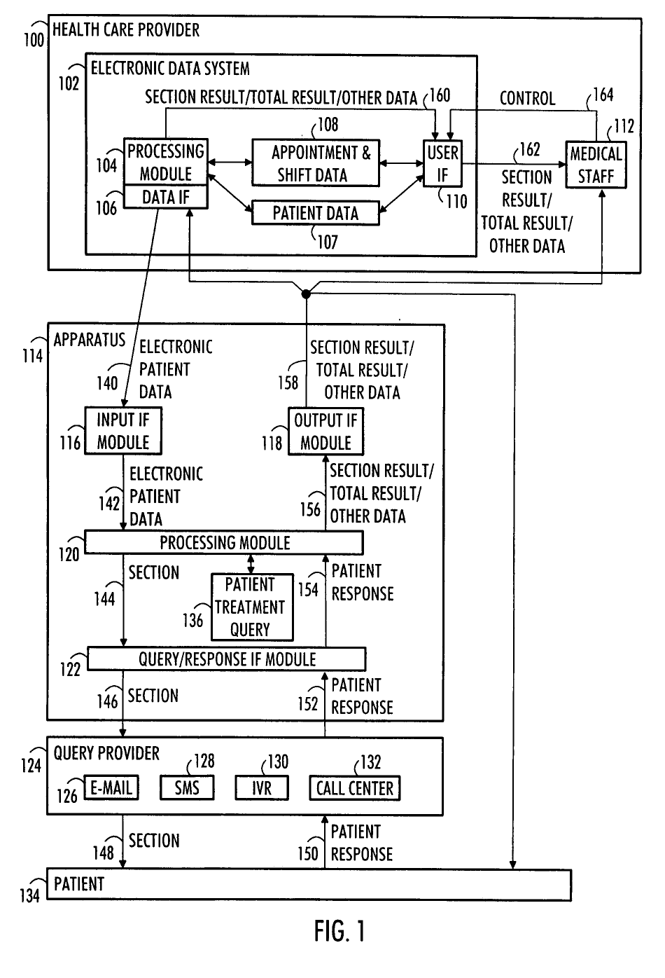

FIG. 1 illustrates embodiments of an apparatus 114. A service provider may operate and maintain the apparatus 114, but the apparatus 114 may also be more or less integrated with an electronic data system 102 of a health care provider 100. The health care provider 100 may have special staff trained to operate and maintain the apparatus 114, or such service may be outsourced as well.

The electronic data system 102 of the health care provider 100 may be a hospital data system, or any other system, or a combination of systems, suited to maintain patient data 107. The electronic data system 102 may, in some embodiments, also be configured to maintain patient 134 appointment times and work shift information of the medical staff 108.

Medical staff 112 of the health care provider 100 may use and control 164 the electronic data system 102. The user interface 110 of the system 102 may be implemented in prior art ways. Such implementations include, but are not restricted to: desktop computers, laptop computers, workstations, portable digital assistants (PDA), mobile phones, portable touch pads with wireless communication means, or other ways to interface with a data system.

The electronic data system 102 also comprises a processing module 104 configured to process the patient data 107, and in some cases also the patient appointment times and work shift information of the medical staff 108.

The electronic data system 102 also comprises a data interface 106 configured to exchange electronic data 106 with the apparatus 114. The data interface 106 may be implemented in prior art ways. Such implementations include, but are not limited to: any wired or wireless telecommunications technique and protocol, such as TCP/IP (Transmission Control Protocol/Internet Protocol) connections, cellular radio connections, WLAN (Wireless Local Area Network) connections, or other ways to transfer data to and from the electronic apparatus 114. The exchange of data may be performed on-demand or in a batch run manner.

The apparatus 114 comprises an input interface module 116 configured to input patient data 140, 142 maintained in the electronic data system 102 of the health care provider 100. As illustrated in FIG. 1, the input interface module 116 may be coupled with the data interface 106 of the electronic data system 102, so that the patient data 140 is inputted electronically. Alternatively, the patient data 140 may be inputted manually into the apparatus 114, by medical staff 112 of the health care provider 100, for example.

The apparatus 114 further comprises a processing module 120 configured to create a patient treatment query 136 comprising a plurality of sections 146. The processing module 120 may be configured to create for each section 146 a plurality of questions interrelated to the same section of the treatment. Additionally, the processing module 120 may also be configured to create for a section 146 a question relating to a value measurable from the patient 134 with a measurement device. The measurement device may be operated by the patient 134: it may be scales, a heart rate monitor, a blood sugar monitor, or some other device capable of measuring a parameter describing the patient 134. The measurement device may also be operated by an external service provider, such as a laboratory.

The processing module 120 is configured to query the sections 144 at predetermined times. The processing module 120 may be configured to determine the predetermined times as regular intervals. The processing module is further configured to determine the regular interval as at least one of a day, a number of days, a week, a number of weeks, a month, a number of months. The patient 134 may be queried a new section 146 once a month, for example, until all sections are queried.

The patient treatment query 136, once created, may be performed by prior art ways. The apparatus 114 may further comprise a query/response interface module 122, via which the section 146, and a patient response 152 to the section 146, are transferred as at least one of electronic mails, text messages of a radio system, interactive voice response data, and/or call center data.

A query provider 124 may process the sections 148 and the patient response 150, especially if interactive voice response or call center is used for the implementation.

Interactive voice response IVR 130 is a technology automating interaction with the patient 134. Pre-recorded voice prompts and menus may be used for the sections 148, and touch-tone telephone keypad entry (such as Dual-Tone Multi-Frequency DTMF) may be used to gather the patient responses 150. Also voice recognition may be used to gather the spoken words of the patient 134 as the patient response 150. IVR may be implemented over standard telephone lines, or over cellular radio network connections, for example.

A call center 132 may handle inbound/outbound communications with the patients, using manual labor. Such a solution may be suitable if the call-center is outsourced, i.e. the scale of operation and/or cheap labor makes it financially viable. Disabled patients unable to use a computer or a mobile terminal may also be queried by the call center 132.

An electronic mail system 126 and/or a text message service 128 may also be used to implement the interaction with the patient. The text message service may be a short message service SMS or a multimedia message service MMS, for example. Any other suitable standard/non-standard wireless or wired communication means capable of implementing textual communication may be used as well. The patient 134 may need to access a computer (connected to a communications network such as the Internet), a mobile terminal operating according to the GSM (Global System for Mobile Communications), WCDMA (Wideband Code Division Multiple Access), WLAN (Wireless Local Area Network) or another wireless communication standard, in order to be able to respond to the sections 148, but in some cases even a normal telephone will do.

It is to be noted that the sections 144 and the patient response 154 need not both be performed in a similar manner, i.e. the sections 144 may be in the form of a text message, but the patient reply 154 may be in the form of an electronic mail message, for example.

The processing module 120 may be configured to process as the patient treatment query 136 a patient quality of life query, a patient treatment compliance query, or another type of query that may be made to the patient 134 in order to obtain information that helps in planning, tracking and/or evaluating the treatment. The patient treatment query 136 may be medically proven, i.e. it may be based on solid research and/or evidence.

One example of a patient quality of life query is 15D developed by professor Harri Sintonen, Department of Public Health, University of Helsinki, Finland. The 15D is a generic, comprehensive, 15-dimensional, standardized, self-administered measure of health-related quality of life that can be used both as a profile and single index score measure. Another quality of life measure is the Nottingham Health Profile (NHP), for example.

The 15D includes fifteen dimensions: mobility, vision, hearing, breathing, sleeping, eating, speech, elimination, usual activities, mental function, discomfort and symptoms, depression, distress, vitality, and sexual activity. Each dimension has five ordinal levels by which more or less of the attribute is distinguished. The patient 134 chooses from each dimension the level which best describes his/her present health status. For instance the dimension sleeping has five levels, from which the patient 134 may choose the answer:

(1) I am able to sleep normally, i.e. I have no problems with sleeping;

(2) I have slight problems with sleeping, e.g. difficulty in falling asleep, or sometimes waking at night;

(3) I have moderate problems with sleeping, e.g. disturbed sleep, or feeling I have not slept enough;

(4) I have great problems with sleeping, e.g. having to use sleeping pills often or routinely, or usually waking at night and/or too early in the morning;

(5) I suffer severe sleeplessness, e.g. sleep is almost impossible even with full use of sleeping pills, or I stay awake most of the night.

The fifteen dimensions of the 15D may be divided into sections 146. The sections 146 may be, for example:

a somatic health section (mobility, vision, hearing, breathing, sleeping, eating, speech, elimination, usual activities); and

a mental health section (mental function, discomfort and symptoms, depression, distress, vitality, and sexual activity).

The processing module 120 is further configured to determine for each section 146 a section result based on a patient response 150, 152 to the section, and to determine a total result based on the section results. In the 15D, the valuation system is based on an application of the multiattribute utility theory. The single index score on a 0-1 scale, representing the overall health-related quality of life, may be calculated from the health state descriptive system by using a set of population-based preference or utility weights.

One example of the patient treatment compliance query is a compliance instrument developed by professor Helvi Kyngäs, Department of Nursing and Health Administration, University of Oulu. The compliance instrument may have 39 statements in the following categories: compliance, sense of normality, support from nurses, physicians, friends and relatives, energy and will-power, motivation, experience of results, fear of complications and acute problems.

For the patient response 150, 152, the compliance instrument uses a five-point Likert scale:

(1) Strongly disagree;

(2) Disagree;

(3) Neither agree nor disagree;

(4) Agree;

(5) Strongly agree.

Responses to a single Likert item may be treated as ordinal data. The patient response 154 may be evaluated by various statistical methods.

A part of the section 148 of the compliance instrument queried from the patient 134 may look as follows:

“Physicians

30 . . . consider my circumstances while planning my treatment

31 . . . are interested also in me, not just in my illness

32 . . . motivate me to treat myself

33 . . . discuss with me about my treatment, and not just tell me what I should do.”

For each of the above questions 30 to 33, the patient 134 is supposed to give an answer using the five-point Likert scale.

The processing module 120 may further be configured to determine the section result and the total result as a narrative textual feedback. The section result and the total result may also be illustrated by numeral or graphical collages. The narrative textual feedback of the compliance instrument may be as follows, for example:

“Normal life: Fine, you have managed to fit in the treatment as a part of your normal life.

Treatment result: You do not feel that you achieve good results with your treatment. Please, think about the positive things you could attain with good treatment. If you do not treat yourself well, please, try to imagine the positive results you could achieve if you just treated yourself well.

Motivation: You have a good motivation regarding your treatment. Please, think about the reasons for your motivation, and try to keep them.

Coping with the treatment: You have strength to treat yourself well. Please, take care of your coping.

Responsibility, will to treat yourself, and cooperation: You should admit more responsibility for treating yourself. Your cooperation with your nurses and doctors could be improved.

Rehabilitation: You do not carry out the rehabilitation instructions. Why not? Please, discuss this with the people treating you.”

The apparatus also comprises an output interface module 118 configured to output the section results and the total result 158 to the patient 134 and the health care provider 100. As illustrated in FIG. 1, the output interface module 118 may act as a direct user interface for the medical staff 112 and the patient 134. Alternatively, the results may pass 160, 162 through the electronic data system 102 to the medical staff 112. The results may also pass (not illustrated in FIG. 1) through the query provider 124 to the patient 134.

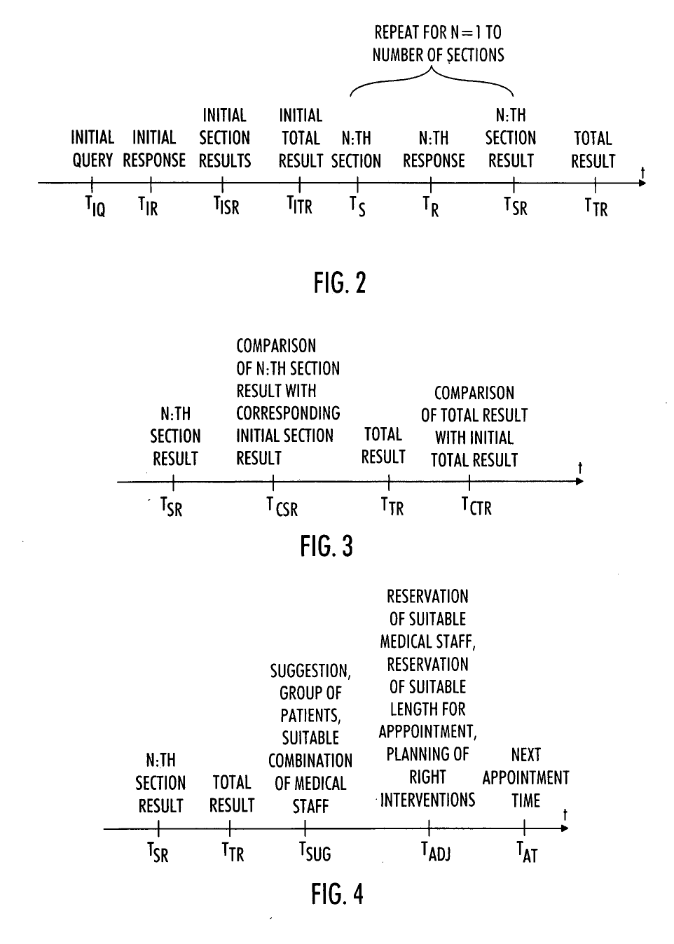

FIGS. 2, 3 and 4 illustrate various dates (the x-axis illustrates time) relating to an electronic patient treatment query 136.

In FIG. 2, the N:th section is queried at time Ts, the N:th patient response is received at time T_{R}, and the N:th section result is compiled at time T_{SR}. These section queries are repeated until the patient treatment query is completed. At time T_{TR}, the total result may then be compiled.

The processing module 120 may be configured to first query the plurality of sections at one predetermined time T_{IQ}. Let us suppose that the initial patient response is received at time T_{IR}. The processing module 120 may be configured to determine for each section an initial section result based on a patient response to the section at time T_{ISR}, and to determine an initial total result based on the section results at time T_{ITR}. The output interface module 118 may be configured to output 156 the initial section results and the initial total result to the patient 134 and the health care provider 100.

The output interface module 118 may be configured to output 158 each section result separately after the patient response to the section, i.e. the feedback is received without unnecessary delays, which may motivate the patient 134, and also allow more time for the health care provider 100 to plan/exercise suitable interventions.

The processing module 120 may be configured to repeat the patient treatment query as an ongoing process in order to arrive at a continuing evaluation of the patient treatment, i.e. the cycle illustrated by the times T_{S}, T_{R}, T_{SR} and T_{TR} is repeated as many times as needed.

The processing module 120 may be configured to compare the section results with the initial section results at time T_{CSR} and the total result with initial total result at time T_{CTR}, and the output interface module 118 may be configured to output 156 the comparison results to the patient 134 and the health care provider 100.

FIG. 4 illustrates three further embodiments.

The input interface module 116 may be configured to input the next appointment time of the patient maintained 108 in the electronic data system 102. The output interface module may be configured to output at least one of the section results and the total result to the health care provider 100 before the next appointment time T_{AT} so that the healthcare provider 100 performs, on the basis of at least one of the section results and the total result, at least one of a reservation of the suitable medical staff, a reservation of a suitable length for the appointment, planning of the right interventions.

The processing module 120 may be configured to generate a suggestion at time T_{SUG} that on the basis of the patient response to the section the next appointment time should be adjusted. The output interface module 118 may be configured to output the suggestion to the health care provider 100.

The processing module 120 may be configured to identify a group of patients that have similar needs, and the output interface module 118 may be configured to output information on the group of patients to the health care provider at time T_{SUG}.

The processing module 120 may be configured to identify a suitable combination of the medical staff for treating the group of patients. The output interface module 118 may be configured to output information on the suitable combination of the medical staff at time T_{SUG} to the health care provider 100. Information 108 both on the appointment times with the patients and on the work shifts of the medical staff 112 may hence be coordinated better.

In Finland, a computer system may not independently make a medical decision. Considering that the law and practice may change, and other jurisdictions may have other principles, the processing module 120 may further be configured to make a decision based on the patient response 154, and the output interface module 118 may further be configured to inform 158 the health care provider 100 of the made decision. Referring to earlier embodiments, the decision may be one of the following, for example: the reservation of the suitable medical staff, the reservation of a suitable length for the appointment, planning the right interventions, adjustment of the next appointment time, identification of the suitable combination of the medical staff.

The apparatus 114 may be implemented as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides a computer program embodied on a carrier and comprising program instructions which, when loaded into a computer, constitute the input interface module 116, the processing module 120, and the output interface module 118 described earlier.

The computer program may be in source code form, object code form, or in some intermediate form, and it may be stored in some sort of carrier, which may be any entity or device capable of carrying the program. Such carriers include a distribution medium, record medium, computer memory, read-only memory, electrical carrier signal, telecommunications signal, and software distribution package, for example. Depending on the processing power needed, the computer program may be executed in a single electronic digital computer or it may be distributed amongst a number of computers.

As was explained earlier, the apparatus 114 may be more or less integrated with the electronic data system 102. The electronic data system 102 may be implemented in a similar fashion as the apparatus 114. Therefore, the computer program (of the apparatus 114) may also partly or wholly run in the electronic data system 102.

Next, an usage scenario example will be described. A web page of the health care provider 100 may contain a link. By clicking the link, the compliance meter (or the apparatus 114) may be contacted. A DM (Diabetes Mellitus) nurse of the medical staff 112 may help the patient 134 in the use of the compliance meter for the first time. The user identifier and the password are coupled with the social security number (or some other identifier used in the electronic data system 102 for identifying the patient unambiguously). While using the compliance meter for the first time, the patient 134 will answer the whole patient treatment query 136, i.e. all sections 146, so that the initial section results and the total result are obtained. These will serve as the basis against which comparisons may later be made, in order to find out whether the situation improves or deteriorates. After the first time use, the patient 134 will answer the sections at regular intervals, in order to arrive at a “rolling” compliance meter. If needed, the patient 134 may be reminded that the next section needs to be answered. The reminders may be transmitted to the patient 134 in an e-mail message, or in a text message of a radio system, for example. The section 148 may be presented in a dynamic web page, whose address will no longer be valid after the patient 134 has responded 150 to the section 148. During a control call, the DM nurse may fetch the current compliance of the patient 134 by clicking a link of the DM nurse on the web page of the health care provider 100. The DM nurse may check the compliance results, the comparison with the earlier/initial results, and other available data before the control call, so that the suitable interventions, reservation of other needed medical staff (such as a physician), etc., may be performed in time. Initial query frequency may be once a week or once a fortnight, but if the therapeutic equilibrium is good, the frequency may be once a month or even at longer intervals. The query frequency may depend, of course, on the type of the medical condition that is treated.

By using the apparatus 114, the medical staff 112 will learn the type of problems that each specific patient 134 has. If the circumstances of the patient 134 change, the medical staff 112 is able to recognize the change and react to it fast. Those patients whose section results and the total result indicate that their treatment is in good balance need to visit the medical staff 112 less often. On the other hand, those patients whose section results and the total result indicate some problems are monitored more closely. All in all, the scarce resources of the health care may be better utilized by the aid provided with the apparatus 114. Experts of the medical staff 112 may serve several different organizations, as the appointment times of the patient groups having different problems may be coordinated so that the resources are utilized most efficiently.

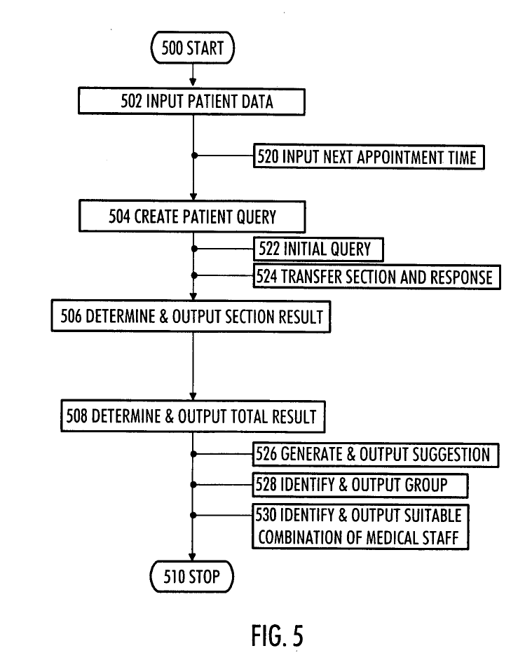

Next, a method will be described with reference to FIG. 5. The method relates to processing of an electronic patient treatment query. The method starts in 500.

In 502, patient data maintained in an electronic data system of a health care provider is inputted.

In 504, a patient treatment query comprising a plurality of sections queried at predetermined times is created.

In 506, for each section a section result is determined based on a patient response to the section, and each section result is outputted to the patient and the health care provider.

In 508, a total result based on the section results is determined, and the total result is outputted to the patient and the health care provider.

The method ends in 510.

The embodiments of the apparatus 114, described earlier, may be applied to the method as well, changing such things that need to be changed.

In 520, the next appointment time of the patient maintained in the electronic data system may be inputted, so that at least one of the section results and the total result may be outputted to the health care provider in 506 and 508 before the next appointment time so that the healthcare provider may perform, on the basis of at least one of the section results and the total result, at least one of a reservation of the suitable medical staff, a reservation of a suitable length for the appointment, planning of the right interventions.

In 522, the plurality of sections may first be queried at one predetermined time, i.e. the whole patient treatment query may be performed at one blow. Initial section results and the initial total result may then be determined and outputted. Later on, the section results may be compared with the initial section results and the total result with initial total result, and the comparison results may be outputted.

In 524, the patient treatment query and the patient response may be transferred as at least one of electronic mails, text messages of a radio system, interactive voice response data, call center data.

In 526, a suggestion that on the basis of the patient response to the section the next appointment time is adjusted may be generated, and the suggestion may be outputted to the health care provider.

In 528, a group of patients that have similar needs may be identified, and information on the group of patients may be outputted to the health care provider.

In 530, a suitable combination of the medical staff for treating the group of patients may be identified, and information on the suitable combination of the medical staff may be outputted to the health care provider.

Even though the invention has been described above with reference to an example according to the accompanying drawings, it is clear that the invention is not restricted thereto but can be modified in several ways within the scope of the appended claims.

1. An apparatus comprising:
an input interface module configured to input patient data maintained in an electronic data system of a health care provider;
a processing module configured to create a patient treatment query comprising a plurality of sections queried at predetermined times, to determine for each section a section result based on a patient response to the section, and to determine a total result based on the section results; and
an output interface module configured to output the section results and the total result to the patient and the health care provider.

2. The apparatus of claim 1, wherein the processing module is further configured to create for each section a plurality of questions interrelated to the same section of the treatment.

3. The apparatus of claim 1, wherein the processing module is further configured to create for a section a question relating to a value measurable from the patient with a measurement device.

4. The apparatus of claim 1, wherein the processing module is further configured to determine the predetermined times as regular intervals.

5. The apparatus of claim 4, wherein the processing module is further configured to determine the regular interval as at least one of a day, a number of days, a week, a number of weeks, a month, a number of months.

6. The apparatus of claim 1, wherein the apparatus further comprises a query/response interface module, via which the section and the patient response to the section are transferred as at least one of electronic mails, messages of a radio system, interactive voice response data, call center data.

7. The apparatus of claim 1, wherein the processing module is further configured to determine the section result and the total result as a narrative textual feedback.

8. The apparatus of claim 1, wherein the output interface module is further configured to output each section result separately after the patient response to the section.

9. The apparatus of claim 1, wherein the processing module is further configured to repeat the patient treatment query as an ongoing process in order to arrive at a continuing evaluation of the patient treatment.

10. The apparatus of claim 9, wherein the processing module is further configured to first query the plurality of sections at one predetermined time, determine for each section an initial section result based on a patient response to the section, and to determine an initial total result based on the section results, and the output interface module is further configured to output the initial section results and the initial total result to the patient and the health care provider.

11. The apparatus of claim 10, wherein the processing module is further configured to compare the section results with the initial section results and the total result with initial total result, and the output interface module is further configured to output the comparison results to the patient and the health care provider.

12. The apparatus of claim 1, wherein the processing module is further configured to process as the patient treatment query at least one of a patient quality of life query, a patient treatment compliance query.

13. The apparatus of claim 1, wherein the input interface module is further configured to input the next appointment time of the patient maintained in the electronic data system, and the output interface module is further configured to output at least one of the section results and the total result to the health care provider before the next appointment time so that the healthcare provider performs, on the basis of at least one of the section results and the total result, at least one of a reservation of the suitable medical staff, a reservation of a suitable length for the appointment, planning of the right interventions.

14. The apparatus of claim 13, wherein the processing module is further configured to generate a suggestion that on the basis of the patient response to the section the next appointment time should be adjusted, and the output interface module is further configured to output the suggestion to the health care provider.

15. The apparatus of claim 13, wherein the processing module is further configured to identify a group of patients that have similar needs, and the output interface module is further configured to output information on the group of patients to the health care provider.

16. The apparatus of claim 15, wherein the processing module is further configured to identify a suitable combination of the medical staff for treating the group of patients, and the output interface module is further configured to output information on the suitable combination of the medical staff to the health care provider.

17. A computer program embodied on a carrier and comprising program instructions which, when loaded into a computer, constitute the following:
an input interface module configured to input patient data maintained in an electronic data system of a health care provider;
a processing module configured to create a patient treatment query comprising a plurality of sections queried at predetermined times, to determine for each section a section result based on a patient response to the section, and to determine a total result based on the section results; and
an output interface module configured to output the section results and the total result to the patient and the health care provider.

18. A method comprising:
inputting patient data maintained in an electronic data system of a health care provider;
creating a patient treatment query comprising a plurality of sections queried at predetermined times;
determining for each section a section result based on a patient response to the section, and outputting each section result to the patient and the health care provider;
determining a total result based on the section results, and outputting the total result to the patient and the health care provider.

19. The method of claim 18, wherein the method further comprises:
creating for each section a plurality of questions interrelated to the same section of the treatment.

20. The method of claim 18, wherein the method further comprises:
creating for a section a question relating to a value measurable from the patient with a measurement device.

21. The method of claim 18, wherein the method further comprises:
determining the predetermined times as regular intervals.

22. The method of claim 21, wherein the method further comprises:
determining the regular interval as at least one of a day, a number of days, a week, a number of weeks, a month, a number of months.

23. The method of claim 18, wherein the method further comprises:
transferring the section and the patient response to the section as at least one of electronic mails, messages of a radio system, interactive voice response data, call center data.

24. The method of claim 18, wherein the method further comprises:
determining the section result and the total result as a narrative textual feedback.

25. The method of claim 18, wherein the method further comprises:
outputting each section result separately after the patient response to the section.

26. The method of claim 18, wherein the method further comprises:
repeating the patient treatment query as an ongoing process in order to arrive at a continuing evaluation of the patient treatment.

27. The method of claim 26, wherein the method further comprises:
querying first the plurality of sections at one predetermined time;
determining for each section an initial section result based on a patient response to the section;
determining an initial total result based on the section results; and
outputting the initial section results and the initial total result to the patient and the health care provider.

28. The method of claim 27, wherein the method further comprises:
comparing the section results with the initial section results and the total result with the initial total result; and outputting the comparison results to the patient and the health care provider.

29. The method of claim 18, wherein the method further comprises:
processing as the patient treatment query at least one of a patient quality of life query, a patient treatment compliance query.

30. The method of claim 18, wherein the method further comprises:
inputting the next appointment time of the patient maintained in the electronic data system; and
outputting at least one of the section results and the total result to the health care provider before the next appointment time so that the healthcare provider performs, on the basis of at least one of the section results and the total result, at least one of a reservation of the suitable medical staff, a reservation of a suitable length for the appointment, planning of the right interventions.

31. The method of claim 30, wherein the method further comprises:
generating a suggestion that on the basis of the patient response to the section the next appointment time should be adjusted; and
outputting the suggestion to the health care provider.

32. The method of claim 30, wherein the method further comprises:
identifying a group of patients that have similar needs; and
outputting information on the group of patients to the health care provider.

33. The method of claim 32, wherein the method further comprises:
identifying a suitable combination of the medical staff for treating the group of patients; and
outputting information on the suitable combination of the medical staff to the health care provider.

34. An apparatus comprising:
means for inputting patient data maintained in an electronic data system of a health care provider;
means for creating a patient treatment query comprising a plurality of sections queried at predetermined times;
means determining for each section a section result based on a patient response to the section;
means for outputting each section result to the patient and the health care provider;
means for determining a total result based on the section results; and
means for outputting the total result to the patient and the health care provider.
